(19) United States
(12) Patent Application Publication
(10) Pub. No.: US 2024/0246376 A1
(43) Pub. Date: Jul. 25, 2024

(54) DEVICE FOR FITTING/REMOVING TIRES

(71) Applicant: M & B ENGINEERING S.r.l., Reggio nell'Emilia (IT)

(72) Inventor: Cristiano TAROZZI, Reggio nell'Emilia (IT)

(73) Assignee: M & B ENGINEERING S.r.l., Reggio nell'Emilia (IT)

(21) Appl. No.: 18/561,352

(22) PCT Filed: May 23, 2022
(86) PCT No.: PCT/IB2022/054784

§ 371 Date: Nov. 16, 2023

(30) Foreign Application Priority Data
May 26, 2021 (IT) 102021000013760

(51) Int. Cl. B60C 25/138

(52) U.S. Cl. CPC B60C 25/138

(57) ABSTRACT

A device for fitting/removing tires comprising one supporting frame associable with a tire changing machine and movable along one substantially vertical direction of work, to vary the level thereof with respect to a rim of a wheel; one working tool associated in a movable manner with the supporting frame at least between a first working position and a second working position and adapted to interact with a tire to fit/remove the tire on/from the rim; one probe member connected to the supporting frame, adapted to abut against the tire and operatively connected to the working tool in such a way as to activate the displacement thereof with respect to the supporting frame from the first working position to the second working position due to the interaction of the probe member itself with the tire.

### TECHNICAL FIELD

The present invention relates to a device for fitting/removing tires.

### BACKGROUND ART

The operations of fitting and removing a tire onto/from a rim of a wheel require great care by the operator performing them in order to avoid excessive stress being applied to the tire itself, which could result in damage both to the sealing area (bead) of the tire with the rim and to the rim itself.

The automatic systems known to date for fitting and removing a tire, which have replaced the use of the hand lever over time, involve the use of tools, such as hooks, which are forcefully inserted between the rim edge and the tire bead and which, by reversing the direction of the force applied, pull the bead out by bringing it above the rim edge or insert it thereunder.

Thus, the tools used in the automatic systems of known type do actually replicate the action of the manual lever used in the past.

From this it follows that the stresses applied on the tire bead by the tool used, which forces the extraction (removing) or insertion (fitting) thereof into the seat by passing from below to above the rim edge and vice versa, are particularly high.

Some of these machines are also provided with expensive and complex sensing systems (mostly provided with triangulation lasers) that provide the tool with the position of the rim edge used as a reference to begin fitting and removing the tire after the bead has been placed above the edge itself. Therefore, the “actual” position of the tire (bead) is not sensed, which after being removed (or uncoupled from the rim) moves away from the rim edge, thus losing its reference.

This results, especially during the operation, in the tool, initially employed to grip the tire bead, vertically sinking along the tire sidewall or crushing it all the way against the bottom edge of the rim without completing the operation.

Likewise, the operator must resume the operation several times for it to be successfully completed, the difficulties being different from time to time depending on the type of tire to be removed (run-flat, soft sidewall, off-road, etc.).

Also, in the fitting operation, the position of the tool is defined with respect to the edge of the rim before starting the operation and normally remains so until the bead is fully inserted into its own seat formed in the rim.

Therefore, there is a phenomenon of increasing tension on the bead itself as the tire mates with the rim through the spindle rotation, and this can damage the structure of the bead itself when the operation is completed.

It is apparent, therefore, that the devices for fitting/removing tires are susceptible to further refinement.

### DESCRIPTION OF THE INVENTION

The main aim of the present invention is to devise a device for fitting/removing tires which allows sensing the presence of the tire and correctly positioning the working tool with respect to the rim.

Another object of the present invention is to devise a device for fitting/removing tires which allows optimizing the fitting and removing operations of a tire on a rim while reducing as much as possible the stresses exerted on the tire itself and avoiding damage to the rim.

Still one object of the present invention is to devise a device for fitting/removing tires that is as independent as possible from the operator's skills.

Another object of the present invention is to devise a device for fitting/removing tires which allows the aforementioned drawbacks of the prior art to be overcome within the framework of a simple, rational, easy and effective to use as well as cost-effective solution.

The aforementioned objects are achieved by this device for fitting/removing tires having the characteristics of claim 1.

### BRIEF DESCRIPTION OF THE DRAWINGS

Other characteristics and advantages of the present invention will become more apparent from the description of a preferred, but not exclusive, embodiment of a device for fitting/removing tires, illustrated by way of an indicative, yet non-limiting example, in the accompanying tables of drawings in which:

FIG. 1 is a side view of the device according to the invention, in an operational configuration;

FIG. 2 is a side view of the device according to the invention, in an additional operational configuration.

### EMBODIMENTS OF THE INVENTION

With particular reference to these figures, reference numeral 1 globally indicates a device for fitting/removing tires.

The device 1 according to the invention comprises at least one supporting frame 2 associable with a tire changing machine and movable along at least one substantially vertical direction of work A to vary the level thereof with respect to a rim C of a wheel.

In more detail, the tire changing machine comprises a bedplate on which a supporting assembly of a rim C is mounted.

More particularly, the supporting assembly comprises a spindle rotating around its own substantially vertical axis, on which the rim C or the wheel (meant as the set of rim C and tire P) to be machined is fixed by means of a corresponding clamping system.

The direction of work A is substantially parallel to the axis of the spindle and the supporting frame 2 is movable close to/away from the rim C.

The supporting frame 2 is also movable along a horizontal direction B close to/away from the rim C in a radial pattern.

The device 1 comprises at least one working tool 3 associated with the supporting frame 2 in a movable manner and adapted to interact with a tire P to fit/remove the tire P onto/from the rim C.

The working tool 3 is locked together with the supporting frame 2 when moving along the direction of work A and along the horizontal direction B.

The working tool 3 is associated with the supporting frame 2 in a movable manner along at least one operating direction D which is transverse to the direction of work A as it moves close to/away from the rim C.

In more detail, the operating direction D has at least one component which is transverse to the direction of work A, so as to allow the radial close/away movement of the working tool 3 with respect to the rim C.

The operating direction D also has at least one component parallel to the horizontal direction B.

Advantageously, the working tool 3 is associated movable in rotation with the supporting frame 2 around at least one axis of work E transverse to the direction of work A so as to displace itself along the operating direction D.

The working tool 3 has an elongated conformation along a relevant longitudinal axis G and is protruding from the supporting frame 2.

Specifically, the working tool 3 protrudes inferiorly from the supporting frame 2.

The working tool 3 comprises at least one fitting element 4 of the tire P. Additionally, the working tool 3 also comprises at least one removing element 5. The fitting element 4 and the removing element 5 extend away from the supporting frame 2. In the embodiment shown in the figures, the fitting element 4 and the removing element 5 are mutually movable from each other.

The fitting element 4 and the removing element 5 are, in use, facing the same side as the supporting frame 2. More specifically, the fitting element 4 and the removing element 5 are both facing downwards.

Specifically, the fitting element 4 comprises an abutment surface 4a, which is substantially flat and adapted to abut against the tire P during a first phase of interaction and pressure of the working tool with the tire itself.

The removing element 5 has a curved conformation that runs transversely with respect to the fitting element 4.

More particularly, the removing element 5 is shaped substantially in the form of a hook, so that it can engage the bead of the tire P, where the hook itself faces the opposite side with respect to the rim C.

The removing element 5 comprises an attachment surface 5a adapted to engage with the tire P and to remove it from the rim C and a guiding surface 5b adapted to operate in conjunction with the fitting element 4 to insert the tire P into the rim C.

Usefully, the fitting element 4 and the removing element 5 are mutually movable around an axis of hinging F substantially parallel to the axis of work E.

In this way, the position of the elements 4,5 can change as a result of the action of external forces, such as e.g. the pressure given by the rim C to the working tool 3, thus reducing the risk of damage to the rim itself.

In more detail, one of the elements 4,5 is associated idle in rotation with respect to the other around the axis of hinging F.

It cannot however be ruled out that the fitting element 4 and the removing element 5 are mutually fixed.

The device 1 is also provided with at least one probe member 6 connected to the supporting frame 2, adapted to abut against the tire P and operatively connected to the working tool 3 in such a way as to activate the displacement thereof with respect to the supporting frame 2 from a first working position to a second working position due to the interaction of the probe member itself with the tire P.

In more detail, in the first working position, the longitudinal axis G of the working tool 3 is arranged substantially vertically, while in the second working position, the longitudinal axis G is inclined. In the second working position, the fitting element 4 faces the rim C.

The probe member 6 is, in turn, locked together with the supporting frame 2 in the movement along the direction of work A and along the horizontal direction B.

Advantageously, the probe member 6 is adapted to activate the displacement of the working tool 3 along the operating direction D from the first working position to the second working position as a result of the interaction with the tire P.

In more detail, the probe member 6 causes the rotation of the working tool 3 around the axis of work E so as to bring it close to the rim C and place it with the fitting element 4 below the edge of the rim itself.

At the same time, the removing element 5 is placed below the bead of the tire P. Thus, the probe member 6 allows the working tool 3 to be brought close to the rim C only at the instant when it is correctly positioned with respect to the tire P.

Usefully, the probe member 6 is associated movable with working tool 3 around at least one axis H,L, and the device 1 comprises movement means 7 operatively connected to the probe member 6 and to the working tool 3.

The probe member 6 is movable between a home position and at least one sensing position wherein it activates the movement means 7 to command the displacement of the working tool 3 from the first operating position to the second operating position.

In more detail, the movement means 7 are adapted to move the working tool 3 in rotation around the axis of work E between the first working position and the second working position as a result of the probe member 6 reaching the sensing position.

The probe member 6, in turn, is moved away from the working tool 3 due to the actuation of the movement means 7.

In this way, during use, the probe member 6 is not in the way of the action of the working tool 3 on the tire P.

Usefully, the device 1 comprises actuating means 8 of the movement means 7 operatively connected to the probe member 6 and configured to actuate the movement means 7 after reaching the sensing position. The actuating means 8 will be described in more detail later on in this disclosure.

The movement means 7 comprise at least one linkage 9,10 connected to the probe member 6 and to the working tool 3 in a kinematic manner.

Usefully, the linkage 9,10 and the probe member 6 are mutually movable in rotation around a first axis H substantially parallel to the axis of work E. The linkage 9,10 and the working tool 3 are mutually movable in rotation around a second axis L substantially parallel to the first axis H.

The movement means 7 also comprise an actuator assembly 11,12 comprising at least one main body 11 associated with the supporting frame 2 and at least one movable body 12 movable by sliding with respect to the main body 11.

In the embodiment shown in the figures, the actuator assembly 11,12 is of the type of a pneumatic cylinder. It cannot however be ruled out that the actuator assembly 11,12 be of a different type.

The movable body 12 is associated movable in rotation with the linkage 9,10 around an axis of rotation M substantially parallel to the first axis H.

In more detail, the linkage 9,10 comprises a first holding element 9 positioned between the movable body 12 and the probe member 6 and a second holding element 10 positioned between the probe member 6 and the working tool 3.

Conveniently, the main body 11 is associated movable in rotation with the supporting frame 2 around an operational axis N substantially parallel to the axis of rotation M.

The sliding of the movable body 12 with respect to the main body 11, thanks to the linkage 9,10 causes the rotation of the probe member 6 around the first axis H and of the working tool 3 around the axis of work E.

In more detail, with the movable body 12 extended with respect to the main body 11, the working tool 3 is in the first working position, while with the movable body 12 retracted with respect to the main body 11, the working tool 3 is in the second working position, close to the rim C.

Thus, the movement of the probe member 6 between the home position and the sensing position causes the retraction of the movable body 12 with respect to the main body 11.

Advantageously, the probe member 6 comprises at least a first portion 13 and at least a second portion 14 movable with respect to the first portion 13 between the home position and the sensing position.

The relative movement of the first portion 13 and of the second portion 14 is adapted to actuate the movement means 7.

The actuating means 8 are operationally connected to the first portion 13 and to the second portion 14 and configured to operate the actuator assembly 11,12.

The actuating means 8 are of the electric type. It cannot however be ruled out that the actuating means 8 be of a different type.

In the embodiment shown in the figures, the first portion 13 comprises a lever element and the second portion 14 comprises a spring.

As a result of the contact with the tire P, the first portion 13 is displaced and causes the contraction of the second portion 14. This contraction is sensed by the actuating means 8 which, in turn, cause the actuation of the actuator assembly 11,12.

It cannot however be ruled out that the probe member 6 have a first portion 13 and a second portion 14 of a different type.

For example, the first portion 13 and the second portion 14 can be made at the contact point between the probe member 6 and the tire. More particularly, in this alternative embodiment, the second portion 14 is of the type of a pin or the like arranged at an ending portion of the first portion 13 and intended to contact the tire P. The second portion 14 is then adapted to be displaced, due to the contact with the tire P, with respect to the first portion 13 that supports it and the actuating means 8 are adapted to sense such displacement by activating, accordingly, the movement means 7.

In an alternative embodiment, the probe member 6 may be made in a single body piece and the actuating means 8 may be adapted to sense the displacement thereof from the home position to the sensing position. For example, the probe member 6 may consist only of the element corresponding to the first portion 13 described above and the actuating means 8 may be adapted to sense the displacement of the pin inserted inside the spring mentioned above.

The operation of the device 1 according to the present invention is as follows.

The removing operation is carried out by placing the device 1 at the rim C with the working tool 3 in the first working position.

The supporting frame 2 and, consequently, the working tool 3 and the probe member 6, is moved downwards along the direction of work A and, in a radial pattern, along the horizontal direction B close to the rim C.

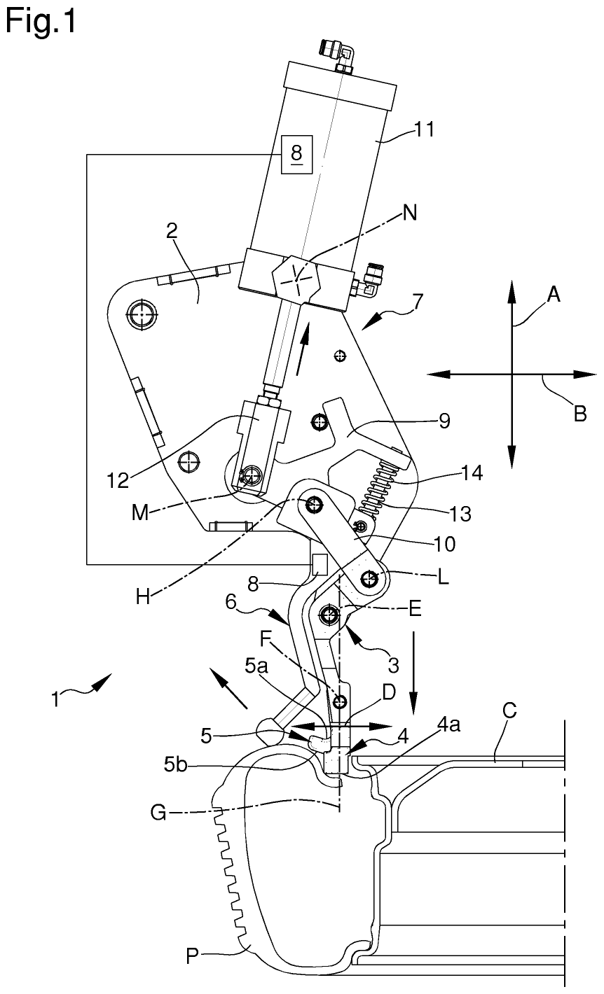

The fitting element 4 contacts the tire P first, through the abutment surface 4a, pushing it downwards. Further downward movement of the supporting frame 2 causes the probe member 6 to interact with the tire P and the relevant movement between the first portion 13 and the second portion 14 (FIG. 1).

Such movement results in the activation of the actuator assembly 11,12 by the actuating means 8.

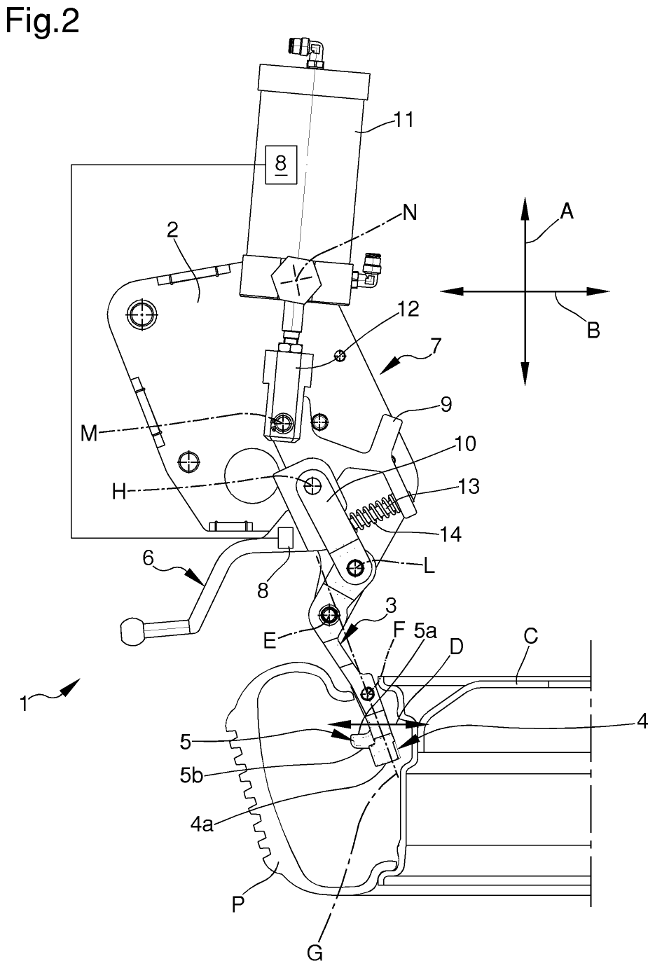

The movable body 12 is retracted and the linkage 9,10 induces the working tool 3 to rotate around the axis of work E towards the rim C and the interaction of the removing element 5 with the bead of the tire P. At the same time, the probe member 6 rotates around the first axis H, away from the working tool 3, so as not to hinder the removing operation (FIG. 2).

More specifically, the removing element 5 moves below the tire P, substantially hooking it.

As a result of the displacement of the bead of the tire P above the removing element 5, the supporting frame 2 is moved upwards along the direction of work A so as to bring the bead of the tire P above the edge of the rim C.

Next, the supporting frame 2 can move along the horizontal direction B close to the rim C in order to bring the bead of the tire P close to the rim itself.

The subsequent rotation of the spindle around its own axis causes the removal of the tire from the rim C.

The fitting operation is carried out by positioning the bead of the tire P above the edge of the rim C and placing thereon the device 1 with the working tool 3 in the first working position.

Next, the supporting frame 2 is moved downwards along the direction of work A so that the fitting element 4 first interacts with the tire P by pushing it inside the seat of the rim C. Similar to what happens during the removing phase, the additional descent of the supporting frame 2 causes the probe member 6 to interact with the tire P and the movement means 7 (FIG. 1) to actuate.

The working tool 3 is rotated around the axis of work E so that the tire P rests on the guiding surface 5b to be guided during the rotation of the spindle.

In actual facts, it has been ascertained that the described invention achieves the intended objects, and in particular, the fact is emphasized that, thanks to the presence of the probe member that causes the working tool to move, the device according to the invention enables the presence of the tire to be sensed and the working tool to be correctly positioned with respect to the rim. In addition, such movement makes it possible to optimize the fitting and removing operations of a tire on a rim by reducing the efforts exerted on the tire itself as much as possible and avoiding damage to the rim.

Finally, the presence of the probe member allows releasing from the operator's skills as much as possible and enables extremely precise and effective tire fitting/removing operations.

1. A device for fitting/removing tires, the device comprising:
at least one supporting frame associable with a tire changing machine and movable along at least one substantially vertical direction of work, to vary the level thereof with respect to a rim of a wheel;
at least one working tool associated in a movable manner with said at least one supporting frame at least between a first working position and a second working position and adapted to interact with a tire to fit/remove said tire on/from said rim; and
at least one probe member connected to said at least one supporting frame, adapted to abut against said tire and operatively connected to said at least one working tool in such a way as to activate the displacement thereof with respect to said at least one supporting frame from said first working position to said second working position due to the interaction of said probe member with said tire.

2. The device according to claim 1, wherein said at least one working tool is associated in a movable manner with said at least one supporting frame between said first working position and said second working position along at least one operating direction transverse to said direction of work close to/away from the rim, said probe member being adapted to activate the displacement of said at least one working tool along said operating direction as a result of the interaction with the tire.

3. The device according to claim 2, wherein said at least one working tool is associated movable in rotation with said at least one supporting frame around at least one axis of work transverse to said direction of work so as to displace along said operating direction.

4. The device according to claim 3, wherein said probe member is associated movable with said at least one working tool around at least one axis, and further comprising movement means operatively connected to said probe member and to said at least one working tool.

5. The device according to claim 4, wherein said probe member is movable between a home position and at least one sensing position wherein the probe member activates said movement means to command the displacement of said at least one working tool from said first operating position to said second operating position.

6. The device according to claim 4, wherein said probe member comprises at least a first portion and at least a second portion movable with respect to said first portion between said home position and said sensing position, the relative movement of said first portion and of said second portion being adapted to actuate said movement means.

7. The device according to claim 4, further comprising actuating means of said movement means operatively connected to said probe member and configured to actuate said movement means after reaching said sensing position.

8. The device according to claim 7, wherein said actuating means are of the electrical type.

9. The device according to claim 4, wherein said movement means are adapted to move in rotation said at least one working tool around said axis of work between said first working position and said second working position after reaching the sensing position by said probe member, the latter being moved away from said at least one working tool as a result of the actuation of said movement means.

10. The device according to claim 4, wherein said movement means comprise at least one linkage kinematically connected to said probe member and to said at least one working tool, wherein said linkage and said probe member are mutually movable in rotation around a first axis substantially parallel to said axis of work, and wherein said linkage and said at least one working tool are mutually movable in rotation around a second axis substantially parallel to said first axis.

11. The device according to claim 10, wherein said movement means comprise an actuator assembly comprising at least one main body associated with said at least one supporting frame and at least one movable body movable sliding with respect to said main body and associated movable in rotation with said linkage around an axis of rotation substantially parallel to said first axis.

12. The device according to claim 11, wherein said main body is associated movable in rotation with said at least one supporting frame around an operational axis substantially parallel to said axis of rotation.

13. The device according to claim 1, wherein said at least one working tool is protruding with respect to said at least one supporting frame and comprises one fitting element of said tire and at least one removing element extending away from said at least one supporting frame and being mutually movable from each other.

14. The device according to claim 13, wherein said fitting element and said removing element are mutually movable around an axis of hinging substantially parallel to said axis of work.

15. The device according to claim 14, wherein one of said fitting element and said removing element is associated idle in rotation with respect to the other around said axis of hinging.

16. A device for fitting/removing tires, the device comprising:
at least one supporting frame associable with a tire changing machine and movable along at least one substantially vertical direction of work;
at least one working tool associated in a movable manner with said at least one supporting frame at least between a first working position and a second working position and adapted to interact with a tire to fit/remove said tire on/from a rim; and
at least one probe member connected to said at least one supporting frame, adapted to abut against said tire and operatively connected to said at least one working tool.
